(19) United States
(12) Patent Application Publication
(10) Pub. No.: US 2025/0210239 A1
(43) Pub. Date: Jun. 26, 2025

(54) Linear Actuator-Based Shutter System for Ultra-High Vacuum Deposition Chambers

(71) Applicants: Alexander Goldstone, Washington, DC (US); Thomas Peter Mlynarski, Washington, DC (US); Sushant Sonde, Westmont, IL (US)

(72) Inventors: Alexander Goldstone, Washington, DC (US); Thomas Peter Mlynarski, Washington, DC (US); Sushant Sonde, Westmont, IL (US)

(21) Appl. No.: 18/932,391

(22) Filed: Oct. 30, 2024

Related U.S. Application Data
(60) Provisional application No. 63/546,629, filed on Oct. 31, 2023.

(51) Int. Cl. H01F 7/20

(52) U.S. Cl. CPC H01F 7/206

(57) ABSTRACT

A linear actuator-controlled magnet carrier slides along guide rails to carry the magnet up and down a hollow cylinder attached to a vacuum chamber. Within the hollow cylinder is a rod connected to an internal shutter, thus moving the magnet along the hollow cylinder will open and close the shutter as desired. This movement can be highly tuned to be smooth, fast, and reliable, depending largely on the performance of the linear actuator chosen for implementation.

This application claims the benefit of U.S. Provisional Application No. 63/546,629, filed Oct. 31, 2023.

### BACKGROUND

Molecular Beam Epitaxy (MBE) systems rely on fast and reliable opening of metal shutters to precisely control exposure time of the substrate to molecular beams. State-of-the-art MBE systems commonly use pneumatic actuators to control shutter opening and closing. In such systems, an electronically controlled valve releases air pressure to operate a bellow which in turn pushes and pulls on a metal bar attached to the shutter by a mechanical hinge. This design is favored for the speed of shutter operation but with a trade off in complexity and durability of design. The system requires pneumatic plumbing which must remain under pressure and can fail unexpectedly. The opening of the shutter is rapid and can be violent enough to damage the bellows, mechanical hinge, and the shutter itself with repeated use. Material deposited on the shutters over time can be discharged into the chamber and onto the growth substrate due to the force of opening/closing.

An alternative shutter system utilizes magnetic fields generated by electric coils to operate a shutter attached to a magnetic rod. These systems suffer from magnetic drift over time decreasing longevity. They function only as well as the calibration of the fields, which can be complex due to the positional field requirements of the shutter. Magnetic coil systems do not allow for visible confirmation of shutter position, lowering confidence in a critical aspect of successful crystal growth. Both pneumatic and electromagnetic coil shutter systems are expensive to replace, costing in the tens of thousands of dollars.

U.S. Pat. Nos. 3,915,764; 6,159,290; 4,851,101; 4,681,773; 5,080,870; describe various mechanisms for operating a shutter.

FIG. 1 depicts a cross-section of an internal shutter design for an MBE system. The shutter MSC1 is attached to a rod MSC2 which slides freely through a hollow cylinder MSC4 directly attached to the vacuum chamber hull MSC3 (show partially). Of the eight shutters on the system only three are visible through the chamber's viewing port. The initial design of this chamber utilized the electro-coil magnet configuration for shutter operation. Three electro-coils are contained in a large metallic cylinder MSC5 as shown in FIG. 2, with a hollow center and that is mounted on the hollow cylinder MSC4. The magnetic field generated by each coil is controlled by a single electric signal sent through a wire MSC6 attached to the top of the cylinder. The speed and fluidity of the shutter motion is determined by the strength of the generated magnetic fields and the delay between activation of each coil. The solid depiction of the coil mount in the diagram demonstrates the opaqueness of this system; the user cannot visually verify whether the shutter is fully opened or whether particles are released from the force of its motion. One is also unable to verify whether an error in the electric signal leads to increased delays between coil activation, preventing the third coil from ‘catching’ the shutter, resulting in it falling shut (or open) due to gravity.

### SUMMARY

The invention disclosure describes a linear actuator-controlled magnet carrier which slides along guide rails to carry the magnet up and down a hollow cylinder attached to a vacuum chamber. Within the hollow cylinder is a rod connected to an internal shutter, thus moving the magnet along the hollow cylinder will open and close the shutter as desired. This movement can be highly tuned to be smooth, fast, and reliable, depending largely on the performance of the linear actuator chosen for implementation.

This invention disclosure describes an improved deposition beam control system for ultra-high vacuum chambers. An exemplary embodiment of the invention consists of a durable, stainless steel guide rail which is firmly mounted to the vacuum system parallel to the direction of linear motion for the internal component to be controlled. The guide rail base allows for the mounting of a linear actuator which extends parallel to the guide rails and allows for easy access to the electronic components which power the actuator. An exemplary embodiment of the invention utilizes a magnet carrier which slides freely and smoothly along the guiderails. The proposed invention reduces friction and complexity of motion to improve reliability of operation and durability of mechanical components compared to prior systems while maintaining precision required for deposition beams.

This invention disclosure presents a shutter control system design which utilizes linear actuators to move external rare-earth (e.g., neodymium) magnets which control the opening and closing of internal shutters via magnetic coupling with the shutter shaft. Each shutter consists of a single linear actuator which moves a carrier for the magnet along guide rails in the direction of the shutter motion. This method presents multiple advantages over current shutter systems. The linear actuator allows for control of momentum for opening and closing, resulting in smoother operation, decreased likelihood of mechanical damage or material discharge, and more precise velocity control throughout the range of motion. Use of high-speed linear actuators achieves the desired operation speeds without the violent force of the pneumatic systems.

Additionally, the design consists of one mechanical component (the actuator) as opposed to three in a pneumatic system (valve, bellows, and hinge) and reduces potential sources of leaks in the MBE system. The design allows for visible confirmation of shutter position. A full set of linearly controlled magnetic shutters can be constructed for a fraction of the cost of comparable pneumatic or electromagnetic systems. This system has failure confined to the linear actuator which can be easily serviced or replaced without disrupting or performing major maintenance on the MBE system.

Such a design is not limited to shutters alone but can be extended to control the motion of any linear component inside the vacuum chamber. This includes substrate swapping components and linear transport components throughout the vacuum chamber. Such components are often controlled manually by external magnets in state-of-the-art systems, but few are mechanically automated. Due to the complexity of shutter operation for state-of-the-art MBE grown material, which requires smooth and reliable automation over long periods, the present inventors have recognized that such systems would benefit from a design which reduces cost and complexity while increasing durability and reliability of operation.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1. is a cross sectional diagram of a prior art vacuum chamber shutter for a particular MBE system.

FIG. 2 is a perspective view of the vacuum chamber of FIG. 1 in a further stage of assembly.

FIG. 3. is a cross-sectional diagram of a vacuum chamber shutter according to one exemplary embodiment of the present invention.

FIG. 4 is a front schematic view of a portion of a shutter system mount.

FIG. 5 is a side schematic view of the portion of the shutter system mount of FIG. 4.

FIG. 6 is a plan schematic view of the portion of the shutter system mount of FIG. 4.

FIG. 7 is a front schematic diagram of the portion of the shutter system mount with a magnet carrier attached to the guide rails.

FIG. 8 is a side schematic diagram of the portion of the shutter system mount with the magnet carrier attached to the guide rails.

FIG. 9 is a plan schematic diagram of the portion of the shutter system mount with the magnet carrier attached to the guide rails.

FIG. 10 is a front schematic diagram of the shutter system mount from FIG. 7 in a further stage of assembly with a linear actuator attached.

FIG. 11 is a side schematic diagram of the system from FIG. 10.

FIG. 12 is a plan schematic diagram of the system from FIG. 10.

FIG. 13 is a front schematic diagram of a completed shutter system mount.

FIG. 14 is a plan schematic diagram of the completed shutter system mount of FIG. 13.

FIG. 15 is a side schematic diagram of the shutter system mount of FIG. 13.

FIG. 16 is a side schematic view of the shutter system mount of FIG. 13 mounted to a particular MBE system.

FIG. 17 is a rear perspective schematic view of FIG. 16.

FIG. 18 is a front perspective schematic view of FIG. 16.

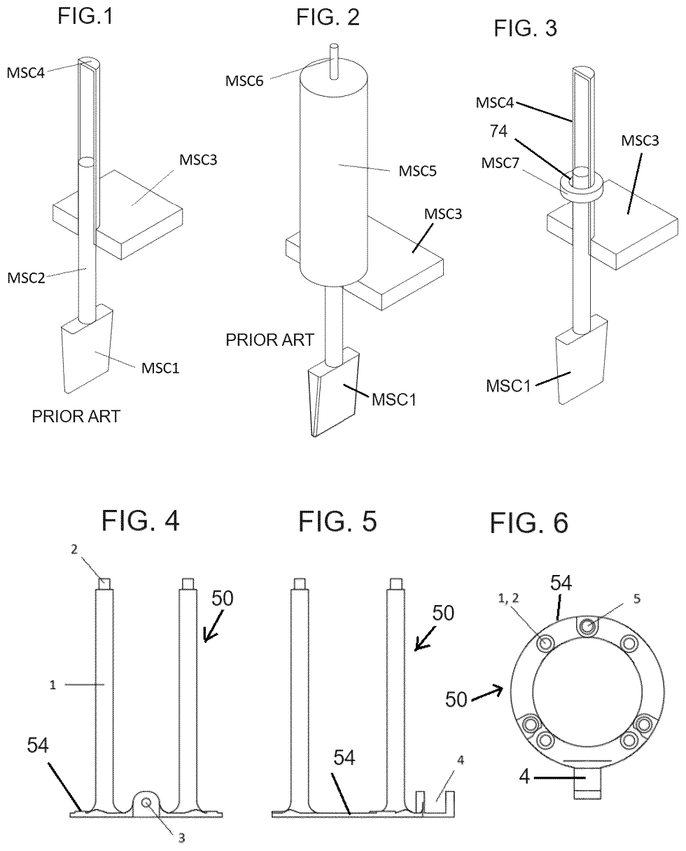

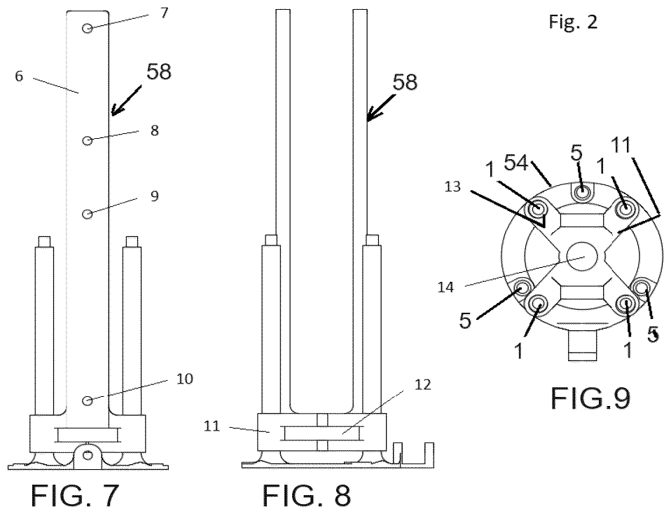

### DETAILED DESCRIPTION

While this invention can be realized in a variety of forms, there are shown in the drawings, and will be described herein in detail, a specific embodiment for a particular vacuum system and shutter application with the understanding that the present disclosure exemplifies the principles of the invention and is not intended to limit the invention to this specific form or application.

This application incorporates by reference U.S. Provisional Application No. 63/546,629, filed Oct. 31, 2023, in its entirety.

FIG. 3 illustrates, in schematic form, an exemplary embodiment of the invention. The embodiment involves controlling the shutter operation with a visible, external neodymium magnet MSC7 mounted to the hollow cylinder MSC4. The speed, fluidity, and position of the shutter can all be verified by the motion of the external magnet, which has sufficient strength to easily operate the shutter in tandem with its own motion. This embodiment is significantly less complex than the pneumatic designs and presents additional advantages over those systems as described in the Background section. A shutter system mount 50 which controls the magnet's motion is described in the following figures.

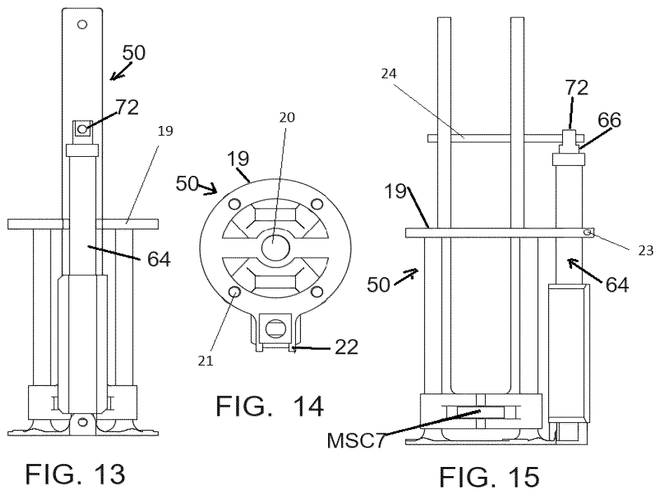

FIGS. 4-6 are schematic views of the shutter system mount 50. The shutter system mount 50 includes guide rails 1 and a ring-shaped base 54 shown from the front, side, and top views. The guide rails 1 are mounted to base 54 and the base 54 is mounted to the vacuum chamber MSC3 with screws 5 through holes shown in FIG. 6. At the end of each guide rail is a peg 2 for attaching the stabilization brace 19 shown in FIG. 13, which helps to keep the guide rails rigid throughout operation. A linear actuator 64 (FIG. 11) rests in a cavity 4 of the base 54 of the mount and is secured through the screw hole 3.

FIGS. 7-9 are schematic diagrams of a magnet carrier attached to the guide rails shown from the front, side, and top views.

FIGS. 7-9 shows the magnet carrier 58 held on the guide rails. The magnet carrier 58 is designed with a base 11 which slides onto the four guide rails 1 through four guide holes 13. A washer shaped neodymium magnet MSC7 with a center hole 74 is placed in a slot 12 in the base 11. The magnet carrier 58 slides onto the hollow cylinder MSC4 through an appropriately sized hole 14 which matches the interior diameter of the magnet hole 74 and the outside diameter of the hollow cylinder MSC4. The magnet carrier 58 should then slide freely on the guide rails 1, carrying the magnet MSC7 up and down the hollow cylinder MSC4, thus lifting the internal shutter MSC1 and MSC2 of the vacuum system. The magnet carrier 58 also consists of two large arms 6 through which the linear actuator 64 is connected via an appropriately sized rod 19 (FIG. 13). The arms 6 includes two holes 9, 10 through which to attach small rods (not shown) to increase rigidity, and two additional holes 7, 8 for connecting to the linear actuator 64. The holes are spaced to accommodate either a 2″ stroke actuator (hole 8) or a 4″ stroke actuator (hole 7).

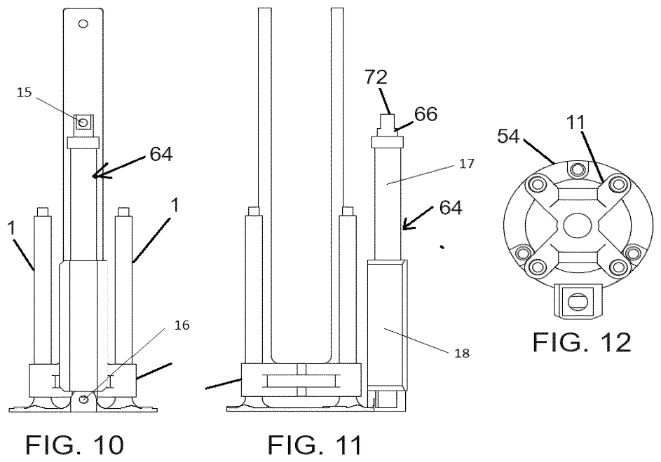

FIGS. 10-12 are diagram of the shutter system mount from FIG. 7 with the linear actuator 64 attached in the appropriate position from front, side, and top views.

FIGS. 10-12 show the attachment configuration for the linear actuator in this shutter system mount. The linear actuator 64 depicted in this design consists of a base 18, an actuator-shield 17, a mounting hole 16, and the actuator 66, which controllably slides partially in and out of the shield and can be attached to the magnet carrier arms through the hole 15 in its tip 72.

The linear actuator 64 can be a pneumatic or hydraulic cylinder, a threaded rod elevated by an internal rotating nut, a rack and pinion mechanism, a piezo-electric linear actuator, or other known linear actuators.

FIGS. 13-15 are diagrams of the complete design with attached stabilization brace 19, neodymium/high-strength magnet MSC7, and connecting rod 24 from front, side, and top views.

FIGS. 13-15 depict the full assembly of the shutter system mount 50. The stabilization brace 19 is attached to the guide rail pegs 21 and guides the hollow cylinder MSC4 through a hole 20 in its center. The brace 19 is designed with two small extrusions 22 to straddle the linear actuator 64 to increase rigidity. The actuator 64 is then secured between the extrusions with a peg or fastener 23. Lastly, a threaded rod is used to connect the tip 72 of the actuator 66 to the magnet carrier arms 6 and secured with nuts. The washer shaped neodymium magnet MSC7 having the center hole 74 is then slid into the magnet carrier slot 12 and aligned with its holes in both the magnet carrier 58 and the stabilization brace 19. The entire shutter system mount 50 is then attached to the vacuum chamber by sliding the hollow cylinder MSC4 through the center holes 14, 20, 74 and mounting the base 5 to the vacuum chamber through the screw locations 5 depicted in FIG. 6.

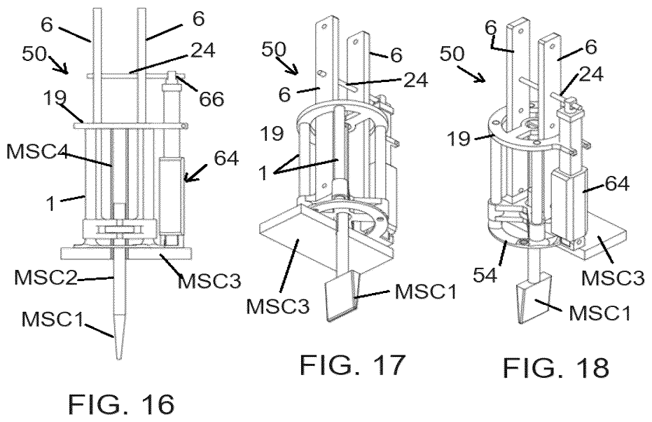

FIGS. 16-18 shows the complete design of the shutter system mount attached to the vacuum chamber. The operation of the invention and the advantages therein are evident from the configuration as shown.

The system described above can thus be understood as a linear actuator-controlled magnet carrier which slides along guide rails to carry the magnet up and down a hollow cylinder attached to a vacuum chamber. Within the hollow cylinder is a rod connected to an internal shutter, thus moving the magnet along the hollow cylinder will open and close the shutter as desired. This movement can be highly tuned to be smooth, fast, and reliable, depending largely on the performance of the linear actuator chosen for implementation.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A system for moving an internal component within a vacuum chamber comprising:
a vacuum chamber, a linear actuator external to the vacuum chamber and a magnet external to the vacuum chamber, the magnet carried by the linear actuator to controllably move the magnet with respect to the vacuum chamber to push and pull internal components of the vacuum chamber.

2. The system according to claim 1, which includes rigid, non-magnetic stainless steel guide rails for guiding linear movement of the magnet, the guide rails attached to a base which can be firmly mounted to said vacuum chamber.

3. The system according to claim 2, which includes a magnet carrier that holds said magnet and slides along the guide rails to move the magnet up and down the vacuum chamber.

4. The system according to claim 3, wherein the linear actuator is connected to the magnet carrier via a threaded rod, rotation of which by the linear actuator controls the motion of the carrier along the vacuum chamber.

5. The system according to claim 4, comprising a stabilization brace ensuring rigidity of the guide rails and the linear actuator.
